(19) United States
(12) Patent Application Publication
(10) Pub. No.: US 2020/0099798 A1
(43) Pub. Date: Mar. 26, 2020

(54) INFORMATION PROCESSING APPARATUS AND NON-TRANSITORY COMPUTER READABLE MEDIUM

(71) Applicant: FUJI XEROX CO.,LTD., Tokyo (JP)

(72) Inventor: Satoshi TAKAOKA, Kanagawa (JP)

(73) Assignee: FUJI XEROX CO.,LTD., Tokyo (JP)

(21) Appl. No.: 16/273,175

(22) Filed: Feb. 12, 2019

(30) Foreign Application Priority Data
Sep. 20, 2018 (JP) 2018-176145

(51) Int. Cl. H04N 1/00; H04N 1/32

(52) U.S. Cl. CPC H04N 1/00244; H04N 1/00923; H04N 1/32106; H04N 1/00344; H04N 2201/3274; H04N 2201/3205; H04N 2201/3278; H04N 2201/3221; H04N 2201/3222; H04N 2201/3202

(57) ABSTRACT

An information processing apparatus includes an obtaining unit that obtains, from an external apparatus, a data transmission condition that specifies a timing at which data regarding a state change of the information processing apparatus is transmitted to the external apparatus and that has been created on a basis of at least of an operation state of the information processing apparatus and a transmission unit that, if the data is generated as a result of a state change of the information processing apparatus, establishes, in accordance with the state change of the information processing apparatus, a first mode in which the data is transmitted to the external apparatus regardless of the timing specified by the data transmission condition or a second mode in which the data is transmitted to the external apparatus in accordance with the timing specified by the data transmission condition.

### CROSS-REFERENCE TO RELATED APPLICATIONS

This application is based on and claims priority under 35 USC 119 from Japanese Patent Application No. 2018-176145 filed Sep. 20, 2018.

### BACKGROUND

### (i) Technical Field

The present disclosure relates to an information processing apparatus and a non-transitory computer readable medium.

### (ii) Related Art

Operation states of apparatuses such as image forming apparatuses are sometimes managed by external apparatuses such as servers.

Japanese Unexamined Patent Application Publication No. 2011-128995 discloses an apparatus that levels out a load of a server by transmitting information to the server at an information transmission time obtained from the server.

Japanese Unexamined Patent Application Publication No. 2015-106759 discloses an apparatus that determines a job execution schedule in a multifunction peripheral (MFP) on the basis of a job history and a power supply state.

Japanese Unexamined Patent Application Publication No. 2006-340223 discloses a system that controls power supplied to an MFP by changing an operation mode on the basis of an operation history created on the basis of an operation state of the MFP.

Japanese Unexamined Patent Application Publication No. 2004-206390 discloses an apparatus that calculates a period suitable for software update on the basis of an operation state calculated from a load condition of a central processing unit (CPU) and the like.

### SUMMARY

In order to manage an operation state of an apparatus from an external apparatus, data regarding the apparatus might be transmitted to the external apparatus. If the data is transmitted to the external apparatus regardless of the operation state of the apparatus, use of the apparatus might be affected.

Aspects of non-limiting embodiments of the present disclosure relate to suppression of an adverse effect upon use of an apparatus compared to when data regarding the apparatus is transmitted to an external apparatus regardless of an operation state of the apparatus.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including an obtaining unit that obtains, from an external apparatus, a data transmission condition that specifies a timing at which data regarding a state change of the information processing apparatus is transmitted to the external apparatus and that has been created on a basis of at least of an operation state of the information processing apparatus and a transmission unit that, if the data is generated as a result of a state change of the information processing apparatus, establishes, in accordance with the state change of the information processing apparatus, a first mode in which the data is transmitted to the external apparatus regardless of the timing specified by the data transmission condition or a second mode in which the data is transmitted to the external apparatus in accordance with the timing specified by the data transmission condition.

### BRIEF DESCRIPTION OF THE DRAWINGS

An exemplary embodiment of the present disclosure will be described in detail based on the following figures, wherein:

FIG. 1 is a block diagram illustrating the configuration of an information processing system according to an exemplary embodiment of the present disclosure;

FIG. 2 is a block diagram illustrating the hardware configuration of an image forming apparatus;

FIG. 3 is a block diagram illustrating functions of the image forming apparatus;

FIG. 4 is a flowchart illustrating a basic process;

FIG. 5 is a diagram illustrating a screen;

FIG. 6 is a flowchart illustrating a process;

FIG. 7 is a diagram illustrating an operation state management table;

FIG. 8 is a flowchart illustrating monitoring of an operation state;

FIG. 9 is a flowchart illustrating the monitoring of an operation state;

FIG. 10 is a diagram illustrating a data transmission condition table;

FIG. 11 is a flowchart illustrating monitoring of a state change;

FIG. 12 is a diagram illustrating a transmission mode management table;

FIG. 13 is a diagram illustrating a failure level table;

FIG. 14 is a flowchart illustrating determination of a communication mode;

FIG. 15 is a diagram illustrating a communication control table;

FIG. 16 is a flowchart illustrating emergency communication;

FIG. 17 is a flowchart illustrating priority communication;

FIG. 18 is a flowchart illustrating general communication;

FIG. 19 is a flowchart illustrating certain period communication;

FIG. 20 is a diagram illustrating a transmission schedule table;

FIG. 21 is a flowchart illustrating certain period priority communication;

FIG. 22 is a flowchart illustrating transmission; and

FIG. 23 is a flowchart illustrating detection of power-off.

### DETAILED DESCRIPTION

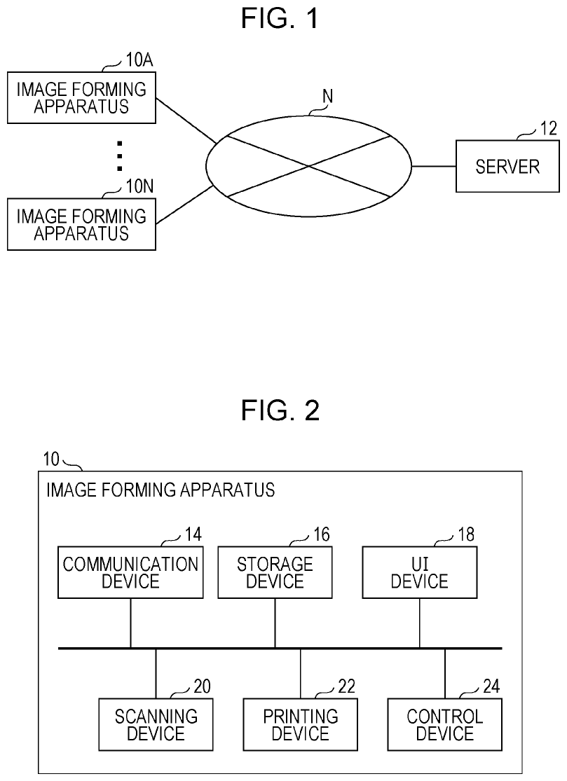

An information processing system according to an exemplary embodiment of the present disclosure will be described with reference to FIG. 1. FIG. 1 illustrates an example of the information processing system according to the present exemplary embodiment.

The information processing system according to the present exemplary embodiment includes one or a plurality of image forming apparatuses and a server 12. In the example illustrated in FIG. 1, the information processing system includes a plurality of image forming apparatuses (image forming apparatuses 10A to 10N). When the image forming apparatuses 10A to 10N need not be distinguished from one another in the following description, the image forming apparatuses 10A to 10N will be generically referred to as “image forming apparatuses 10”. The image forming apparatuses 10 and the server 12 have a function of communicating with one another through a communication path N such as the Internet or another network. The communication may be wireless communication or wired communication.

Each image forming apparatus 10 at least has a printing function, a scanning function, a copying function, a facsimile function, or the like. Each image forming apparatus 10 may be an apparatus that has only one of the above functions, such as a printer or a scanner, or may be a so-called “multifunction peripheral (MPF)”, which has a plurality of functions.

The server 12 collects, from the image forming apparatuses 10, operation information indicating operation states of the image forming apparatuses 10 and creates data transmission conditions on the basis of the operation states of the image forming apparatuses 10. The data transmission conditions are data specifying timings (e.g., schedules) at which the image forming apparatuses 10 transmit data regarding changes in the operation states thereof to the server 12. The data regarding changes in the operation states will be referred to as “state change data” hereinafter.

The hardware configuration of each of the image forming apparatuses 10 will be described in detail hereinafter with reference to FIG. 2. FIG. 2 illustrates the hardware configuration of the image forming apparatus 10.

A communication device 14 is a communication interface that has a function of transmitting information to other apparatuses and a function of receiving information from the other apparatuses. The communication device 14 may have a wireless communication function or a wired communication function.

A storage device 16 includes one or a plurality of storage areas for storing various pieces of information. The storing areas may be, for example, logical partitions or logical drives set in a hard disk drive, a memory, or the like. A plurality of storage devices (physical drives) may be provided for the image forming apparatus 10 and defined as separate storage areas. Such storage areas may be combined with one another.

A user interface (UI) device 18 includes an operation unit and a display unit. The operation unit is an input device such as a keyboard. The display unit is a display device such as a liquid crystal display or an electroluminescent (EL) display. A UI device (e.g., a touch panel or an operation panel) that operates as both an operation unit and a display unit may be used as the UI device 18.

A scanning device 20 functions as a scanner. The scanning device 20 scans an image of a document to generate image data.

A printing device 22 functions as a printer. The printing device 22 receives data to be printed (image data, document data, etc.) and prints an image, text, or the like on a recording medium such as a sheet.

A control device 24 controls the components of the image forming apparatus 10. The control device 24 includes, for example, one or a plurality of processors (e.g., CPUs), a memory, and the like.

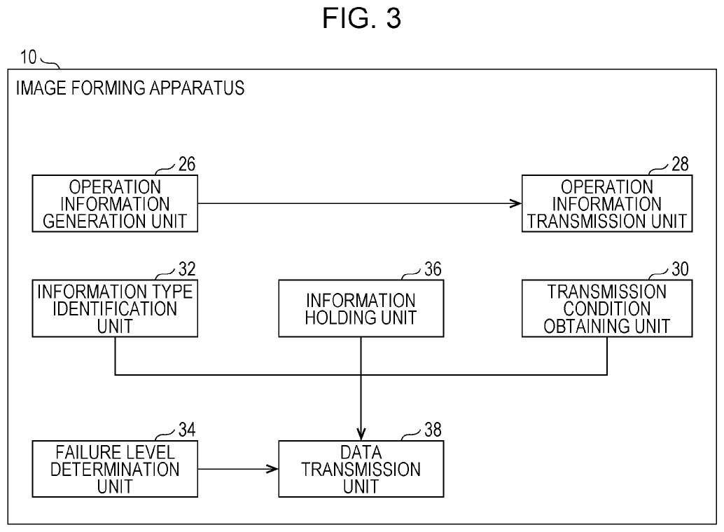

The functions of each of the image forming apparatuses 10 will be described in detail hereinafter with reference to FIG. 3. FIG. 3 illustrates the functions of the image forming apparatus 10.

An operation information generation unit 26 monitors the operation state of the image forming apparatus 10 and generates operation information indicating the operation state.

An operation information transmission unit 28 transmits the operation information generated by the operation information generation unit 26 to the server 12.

A transmission condition obtaining unit 30 obtains, from the server 12, data transmission conditions generated by the server 12.

An information type identification unit 32 identifies a type of state change indicated by state change data. If the state of the image forming apparatus 10 changes, the image forming apparatus 10 generates state change data indicating the state change. If a failure occurs in the image forming apparatus 10, for example, the image forming apparatus 10 generates state change data indicating the failure. The information type identification unit 32 identifies a type (e.g., a failure) of state change of the image forming apparatus 10 on the basis of the state change data. By identifying the type of state change, a cause (e.g., a failure) of the state change data is identified. The state change data may be generated by a component of the image forming apparatus 10 in which the state change has occurred or by the control device 24.

The information type identification unit 32 also establishes, on the basis of a type of state change (a cause of state change data), one of transmission modes specifying a timing at which the image forming apparatus 10 transmits state change data to the server 12. The transmission modes include a mode in which state change data is immediately transmitted certainly, a mode in which state change data is certainly transmitted within a certain period of time, a mode in which state change data is transmitted within a certain period of time, and the like. The transmission modes will be described in detail later.

A failure level determination unit 34 determines, if a failure occurs in the image forming apparatus 10, a level of the failure.

An information holding unit 36 holds state change data.

A data transmission unit 38 transmits the state change data held by the information holding unit 36 to the server 12.

Not all pieces of state change data need to be transmitted to the server 12. State change data may or may not be transmitted to the server 12 depending on, for example, a type of state change. That is, a type of state change to be transmitted is determined in advance, and the data transmission unit 38 transmits, to the server 12, data regarding the type of state change to be transmitted.

The data transmission unit 38 transmits state change data to the server 12 in accordance with, for example, a normal communication mode, a priority communication mode, or an emergency communication mode. In the normal communication mode, state change data is transmitted to the server 12 at a timing (schedule) specified in data transmission conditions. In the priority communication mode, state change data is divided into a plurality of pieces and transmitted to the server 12. In the emergency communication mode, state change data is transmitted to the server 12 without taking into consideration a current processing state of the image forming apparatus 10 and the like.

If a transmission mode established by the information type identification unit 32 is the mode in which state change data is immediately transmitted certainly, a type of state change (a cause of state change data) is a failure, and a level of the failure is high (e.g., equal to or higher than a threshold), for example, the data transmission unit 38 transmits the state change data to the server 12 in the emergency communication mode. If the transmission mode established by the information type identification unit 32 is the mode in which state change data is immediately transmitted certainly but other conditions are different from above, the data transmission unit 38 transmits the state change data to the server 12 in the priority communication mode.

If the image forming apparatus 10 is transmitting another piece of state change data to the server 12, the data transmission unit 38 stops transmitting the other piece of state change data and transmits state change data indicating a failure to the server 12. After the transmission is completed, the data transmission unit 38 may resume the transmission of the other piece of state change data. If the other piece of state change data indicates a failure and a level of the failure is high, the data transmission unit 38 may transmit a current piece of state change data to the server 12 after completing the transmission of the other piece of state change data. If the level of the failure is low, the data transmission unit 38 may stop transmitting the other piece of state change data and transmit the current piece of state change data to the server 12. After completing the transmission of the current piece of state change data, the data transmission unit 38 may resume the transmission of the other piece of state change data.

If the transmission mode identified by the information type identification unit 32 is the mode in which state change data is certainly transmitted within a certain period of time, the data transmission unit 38 divides the certain period of time into a plurality of parts and transmits state change data to the server 12 within each section in accordance with a timing specified in data transmission conditions. If it is difficult to transmit state change data (e.g., when the image forming apparatus 10 is off or when state change data whose degree of emergency is high (e.g., state data indicating a failure) is being transmitted), the data transmission unit 38 changes a timing at which the state change data is transmitted to a next timing. If there are no more timings, the data transmission unit 38 may transmit the state change data to the server 12 in the priority communication mode.

If the transmission mode identified by the information type identification unit 32 is the mode in which state change data is transmitted within a certain period of time, the data transmission unit 38 newly sets a next timing (schedule) without transmitting a current piece of state change data when transmission of another piece of state change data is performed or while another piece of state change data is being transmitted. If a period for which state change data is not transmitted (delay period) exceeds a predetermined period of time as a result of the new setting of the schedule, the data transmission unit 38 may discard (delete) the state change data.

The data transmission unit 38 may determine a plurality of data transmission periods (schedules) on the basis of operation information and information indicated by data transmission conditions. If it is difficult to determine schedules, the data transmission unit 38 may, for example, transmit state change data to the server 12 when the image forming apparatus 10 is not operating but on (e.g., at night).

If the image forming apparatus 10 is off at a time of transmission of state change data and the transmission mode is the mode in which state change data is immediately transmitted certainly or the mode in which state change data is certainly transmitted within a certain period of time, the data transmission unit 38 may transmit the state change data to the server 12 in the emergency communication mode after the image forming apparatus 10 is turned on. If the transmission mode is the mode in which state change data is transmitted within a certain period of time, the data transmission unit 38 may newly set a schedule of transmission.

The server 12 includes, for example, a communication device, a storage device, and a control device. The communication device is a communication interface. The storage device stores various pieces of information (e.g., information transmitted from the image forming apparatus 10). The control device controls the components of the server 12.

The operation of the image forming apparatus 10 according to the present exemplary embodiment will be described in detail hereinafter. An MFP will be taken as an example of the image forming apparatus 10 (referred to as an “MFP 10”) in the following description to describe the operation of the image forming apparatus 10.

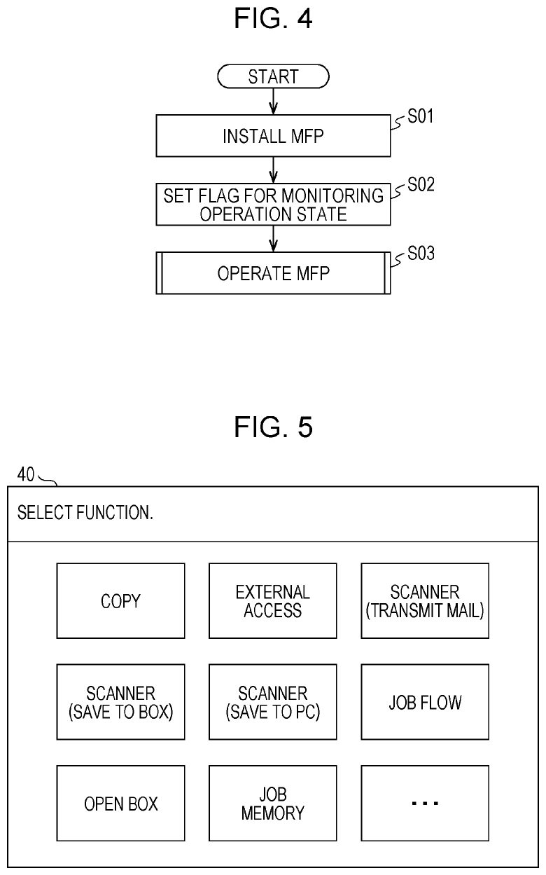

A basic process will be described with reference to FIG. 4. FIG. 4 is a flowchart illustrating the basic process.

First, the MFP 10 shipped from a factory (default state) is installed (step S01). The MFP 10 is installed by unpacking the MFP 10 and making various settings for the MFP 10. Being turned on, the MFP 10 in the default state is activated, and a setting screen is displayed on the display unit of the UI device 18. FIG. 5 illustrates an example of the setting screen. A setting screen 40 includes information for making various settings and icons for setting a function of forming an image (e.g., a printing function) and issuing an execution instruction. A user makes the various settings on the setting screen 40. For example, the user makes network settings, security settings such as a password, and the like.

After the installation is completed, the operation information generation unit 26 sets a flag for monitoring an operation state (step S02). When a flag has been set, the operation state of the MFP 10 is monitored for a predetermined period of time.

The MFP 10 then starts to operate (step S03).

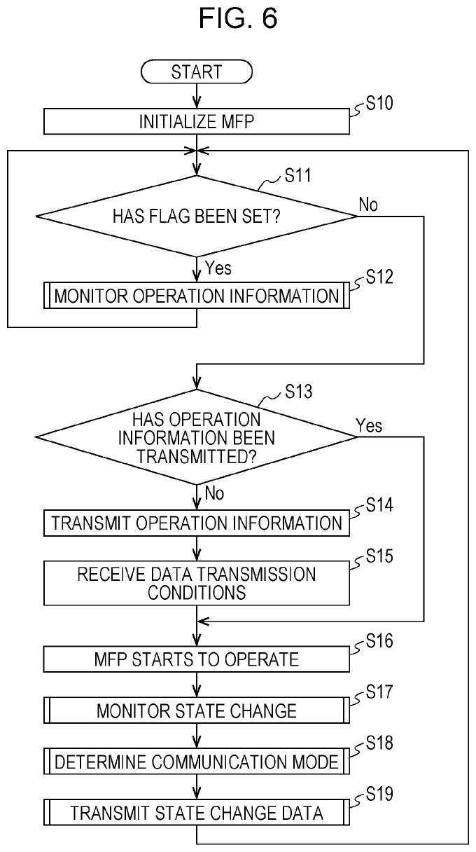

A process after the MFP 10 starts to operate will be described in detail hereinafter with reference to FIG. 6. FIG. 6 is a flowchart illustrating the process after the MFP 10 starts to operate.

First, the MFP 10 is initialized, and the operation information generation unit 26 initializes operation information held by the MFP 10 (step S10).

If a flag for monitoring an operation state has been set (YES in step S11), the operation information generation unit 26 monitors the operation state of the MFP 10 and generates operation information indicating the operation state (step S12). Step S12 will be described in detail later.

If a flag has not been set (NO in step S11) and the MFP 10 has not transmitted operation information to the server 12 (NO in step S13), the operation information transmission unit 28 transmits the operation information to the server 12 (step S14). When a flag has not been set, the monitoring of the operation state of the MFP 10 has already ended.

The server 12 generates data transmission conditions on the basis of operation information transmitted from MFPs 10 and transmits information indicating the data transmission conditions to the MFPs 10.

The transmission condition obtaining unit 30 receives the information indicating the data transmission conditions transmitted from the server 12 (step S15).

If the MFP 10 has already transmitted the operation information to the server 12 (YES in step S13), the process proceeds to step S16. In this case, the MFP 10 has already received information indicating data transmission conditions from the server 12.

After the monitoring of the operation state of the MFP 10 ends, the MFP 10 is used and starts to operate (step S16).

Whether the operation state of the MFP 10 has changed is then monitored (step S17), and if the operation state of the MFP 10 has changed, a communication mode for state change data is determined (step S18). The MFP 10 transmits the state change data to the server 12 in the determined communication mode (step S19). Steps S17 to S19 will be described in detail later.

The operation state of the MFP 10 is thus monitored, and data transmission conditions are determined on the basis of the operation state. If the operation state of the MFP 10 changes, the MFP 10 transmits state change data to the server 12 in a determined communication mode.

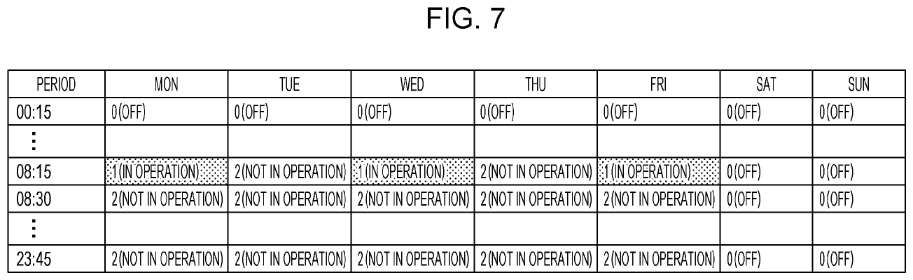

The monitoring of the operation state performed in step S12 will be described in detail hereinafter with reference to FIGS. 7 to 9.

FIG. 7 illustrates an example of an operation state management table. The operation information generation unit 26 monitors the operation state of the MFP 10 and generates the operation state management table as an example of the operation information. The operation state management table is, for example, a table indicating operation states in one week. A monitoring period (e.g., 15 minutes) is determined, for example, for each day of the week (from Monday to Sunday). The operation information generation unit 26 monitors the operation state of the MFP 10 in the monitoring period determined for each day and generates an operation state management table on the basis of a result of the monitoring. As a result of the initialization performed in step S10, all values in the operation state management table are set to 0. 0 indicates that the MFP 10 is off.

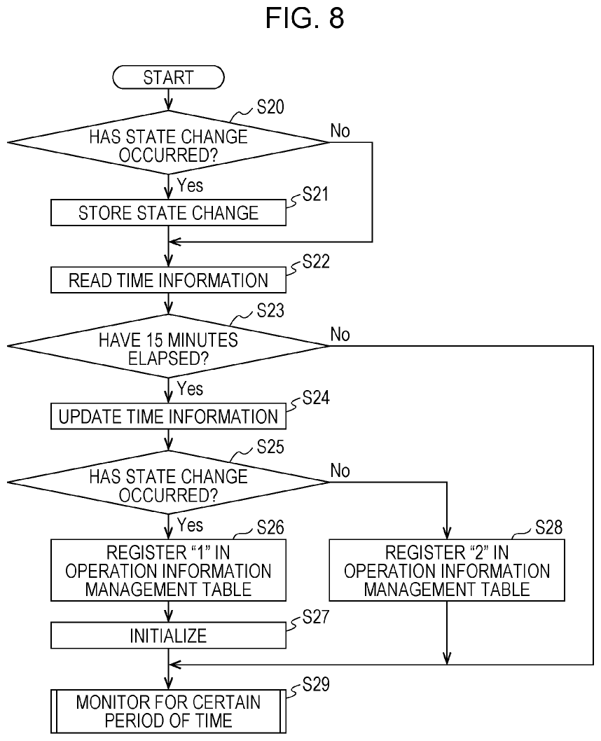

The generation of an operation state management table (monitoring of an operation state) will be described in detail with reference to FIG. 8. FIG. 8 is a flowchart illustrating the generation of an operation state management table.

If an operation state of the MFP 10 changes (YES in step S20), the operation information generation unit 26 stores information indicating the state change in the storage device 16 (e.g., a nonvolatile memory) (step S21). If the user operates an operation panel or issues a printing instruction to the MFP 10 from a personal computer (PC) in a network or the MFP 10 performs a process for forming an image, for example, the operation information generation unit 26 identifies such an operation as a state change and stores information indicating the state change in the storage device 16. That is, if the operation state of the MFP 10 has changed, the operation information generation unit 26 stores information indicating the state change in the storage device 16.

If the operation state of the MFP 10 does not change (NO in step S20), the process proceeds to step S22.

Next, the operation information generation unit 26 reads time information (e.g., information indicating a day and time) from the storage device 16 (e.g., a nonvolatile memory) (step S22). As described later, the time information is updated at predetermined time intervals (e.g., every 15 minutes).

The operation information generation unit 26 compares the day and the time indicated by the time information read from the storage device 16 with a present day and a present time.

If 15 minutes have elapsed since the day and the time indicated by the time information (YES in step S23), the operation information generation unit 26 updates the time information held by the storage device 16 to time information indicating the present day and the present time (step S24). If 15 minutes have not elapsed (NO in step S23), the process proceeds to step S29.

If the operation state of the MFP 10 has changed (YES in step S25), the operation information generation unit 26 registers a value of 1, which indicates “in operation”, in a field of a corresponding day and a corresponding time (a field of the day and the time indicated by the time information) of the operation state management table (step S26). The operation information generation unit 26 then initializes (deletes) the information indicating the state change held by the storage device 16 (step S27).

If the operation state of the MFP 10 has not changed (NO in step S25), the operation information generation unit 26 registers a value of 2, which indicates “not in operation”, in the field of the corresponding day and the corresponding time (the field of the day and the time indicated by the time information) of the operation state management table (step S28).

Next, the process proceeds to step S29 (monitoring for a certain period of time).

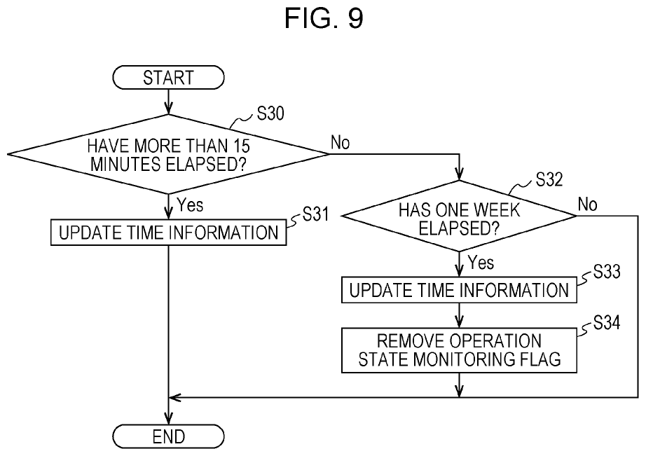

Step S29 will be described hereinafter with reference to FIG. 9. FIG. 9 is a flowchart illustrating step S29.

If more than 15 minutes have elapsed since the day and the time indicated by the time information (YES in step S30), the operation information generation unit 26 updates the time information held by the storage device 16 to time information indicating the present day and the present time (step S31). If more than 15 minutes have elapsed, the MFP 10 has remained off for that period, and the time information has not been updated. Since all the values in the operation state management table are set to 0 as a result of the initialization performed in step S10, the values remain at 0 unless the values are changed to 1 or 2 in accordance with “in operation” or “no in operation”. Values corresponding to periods in which the MFP 10 was off, therefore, remain at 0.

The process then returns to step S20 illustrated in FIG. 8, and whether the operation state of the MFP 10 has changed is monitored at intervals of 15 minutes.

If more than 15 minutes have not elapsed (NO in step S30) and one week has elapsed since the MFP 10 was turned on (YES in step S32), the operation information generation unit 26 updates the time information held by the storage device 16 to time information indicating the present day and the present time (step S33). The operation information generation unit 26 then removes the operation state monitoring flag (step S34). The process returns to step S11 illustrated in FIG. 6. Since the flag has been removed, step S13 and later steps are performed.

As described above, the operation information generation unit 26 monitors the operation state (presence or absence of a state change) of the MFP 10 at intervals of 15 minutes and registers a value (0, 1, or 2) indicating a result of the monitoring in the operation state management table. If a period for which the operation state is monitored is set to one week, the monitoring of the operation starts ends one week after a start of the monitoring of the operation state.

FIG. 7 illustrates operation states in one week. For example, a value of 1 is associated with a time period 08:01 to 08:15 on Monday, Wednesday, and Friday, which means that the MFP 10 operated in these periods. For example, the user operated the MFP 10 or the MFP 10 performed a process for forming an image or received data from an external apparatus, which caused a state change.

In periods associated with a value of 2, the MFP 10 was not operating (not in operation). That is, although the MFP 10 was on, the operation state of the MFP 10 had not changed.

In periods associated with a value of 0, the MFP 10 was off.

Although the operation state (presence or absence of a state change) is monitored at intervals of 15 minutes in the above example, a system manager or the like may change the length of the intervals. In addition, although the monitoring period is one week, the system manager or the like may change the length of the monitoring period.

After an operation state management table indicating operation states in one week is generated, the operation information transmission unit 28 transmits data regarding the operation state management table to the server 12. For example, the operation information transmission unit 28 transmits the data regarding the operation state management table to the server 12 as an extensible markup language (XML) file or the like using a POST request method of a hypertext transfer protocol (HTTP) or a hypertext transfer protocol secure (HTTPS). In response to the transmission, the operation information transmission unit 28 receives information indicating data transmission conditions from the server 12 as an XML file or the like. The information indicating the data transmission conditions is stored in the storage device 16. If information indicating data transmission conditions is stored in the storage device 16, it is determined that operation information has already been transmitted.

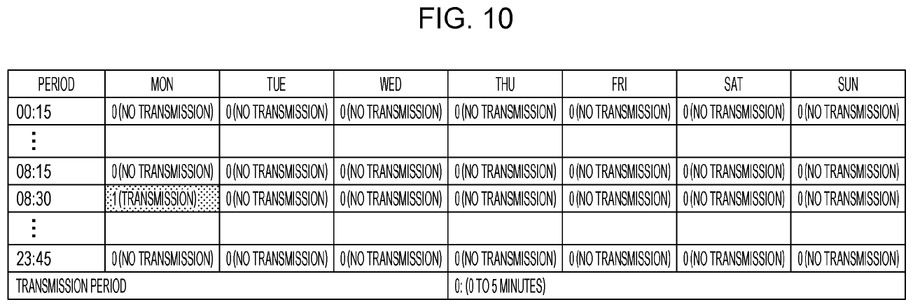

Data transmission conditions will be described hereinafter with reference to FIG. 10. FIG. 10 illustrates an example of a data transmission condition table. The data transmission condition table indicates transmission conditions in one week as with the operation state management table. As with the operation state management table, a transmission period (e.g., 15 minutes) is determined for each day of the week (from Monday to Sunday).

In periods associated with a value of 0, state change data is not transmitted (“no transmission”). In a period associated with a value of 1, state change data is transmitted (“transmission”).

A transmission period is set in periods when the MFP 10 is on but is not operating. A period from 08:16 to 08:30 on Monday, for example, is set as a transmission period. In this period, the MFP 10 is not operating (refer to FIG. 7). Other periods are determined as non-transmission periods.

A method for determining data transmission conditions will be described. Data transmission periods are determined, for example, by the control device of the server 12. The control device of the server 12 refers to the operation state management table transmitted from the MFP 10 and sets a period when the MFP 10 is on but is not operating as a transmission period of the MFP 10. A transmission period of the MFP 10 is thus set in a period when the MFP 10 is not operating (i.e., a period when a load of the MFP 10 is relatively small). In doing so, an increase in the load of the MFP 10 in the period is suppressed compared to when the MFP 10 in operation transmits state change data to the server 12, and use of the MFP 10 is not affected in the period.

The control device of the server 12 may determine a transmission period on the basis of a load of the server 12. For example, the control device of the server 12 sets a period when the MFP 10 is on but is not operating and the load of the server 12 is equal to or smaller than a threshold as a transmission period of the MFP 10. That is, a transmission period of the MFP 10 is set in a period when the loads of the MFP 10 and the server 12 are expected to be relatively small. In doing so, the load of the server 12 is reduced compared to when the load of the server 12 is not taken into consideration.

A plurality of MFPs 10 might be connected to the server 12 and transmit data regarding operation state management tables thereof to the server 12. In this case, the control device of the server 12 determines data transmission conditions on the basis of the operation state management tables. For example, the control device of the server 12 identifies, for each of the MFPs 10, a period when the MFP 10 is on but is not operating and sets a transmission period of the MFP 10 in the period. At this time, the control device of the server 12 determines the transmission period of each MFP 10 such that transmission periods of the MFPs 10 do not overlap. As a result, the MFPs 10 transmit state change data to the server 12 in different periods. For example, a transmission period of an MFP 10A is set in a period from 08:16 to 08:30 on Monday, a transmission period of an MFP 10B is set in a period from 08:16 to 08:30 on Tuesday. As a result, the load of the server 12 is reduced compared to when the MFPs 10 transmit state change data to the server 12 in accordance with the same schedule.

If it is difficult to set the transmission periods of the MFPs 10 such that the transmission periods do not overlap, the control device of the server 12 sets the transmission periods of the MFP 10 such that the number of overlapping transmission periods becomes as small as possible.

A process after the monitoring of the operation state ends and the server 12 transmits data regarding the data transmission condition table to the MFP 10 will be described hereinafter. After the data regarding the data transmission condition table is stored in the MFP 10, the process is performed in accordance with steps S16 to S19 illustrated in FIG. 6.

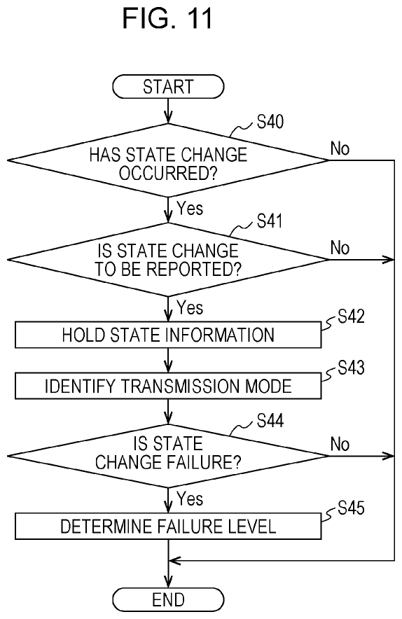

Step S17 (monitoring of a state change) illustrated in FIG. 6 will be described in detail hereinafter with reference to FIG. 11. FIG. 11 is a flowchart illustrating the monitoring of a state change.

If the operation state of the MFP 10 changes (YES in step S40), the information type identification unit 32 determines whether to report the state change to the server 12 (step S41). For example, types of state change that need to be reported are determined in advance. The information type identification unit 32 identifies a type of state change that has occurred and determines, on the basis of the type, whether to report the state change.

If data indicating the state change is data regarding the use frequency of the MFP 10, data regarding a failure of the MFP 10, data regarding prediction of a failure of the MFP 10, data regarding payment for the MFP 10, data regarding replacement of a consumable of the MFP 10, data regarding a mechanical option of the MFP 10, or data regarding the power consumption of the MFP 10, for example, the information type identification unit 32 determines that the state change needs to be reported. It is needless to say that other types of state change may be transmitted.

If the state change is to be reported (YES in step S41), the information holding unit 36 holds the state change data (step S42). For example, the state change data is stored in the storage device 16. The information holding unit 36 associates identification information (e.g., an identifier (ID)) for identifying the state change data to be transmitted with the state change data and sets the identification information in a communication array (communication control table) of the state change data to be transmitted. As a result, the state change data is queued in the array. As described later, basically the MFP 10 transmits state change data to the server 12 in order of specification in a communication control table, but depending on the transmission mode, a piece of state change data whose degree of emergency is high takes priority in transmission over other pieces of state change data (transmitted earlier than the other pieces of state change data) regardless of the order. The communication control table will be described in detail later.

Next, the information type identification unit 32 identifies a transmission mode on the basis of the type of state change (step S43).

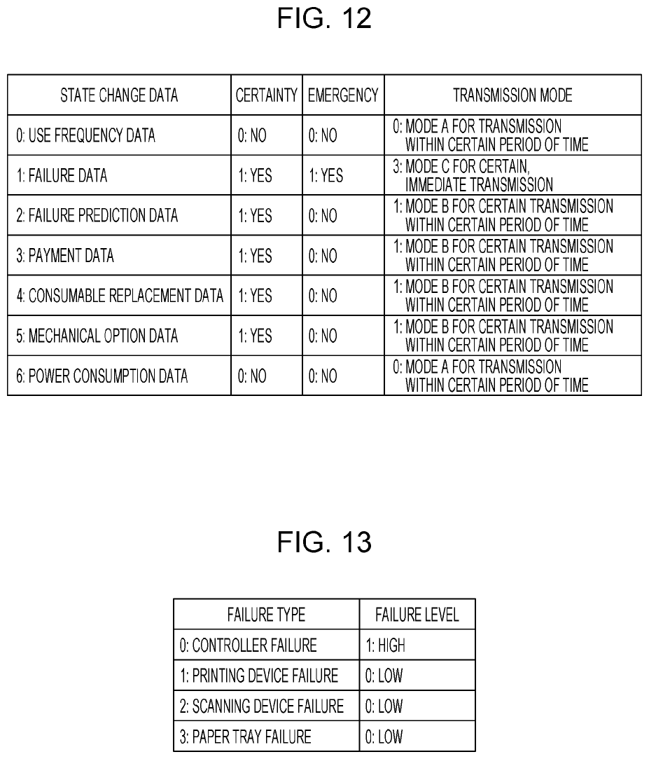

A specific example of the transmission modes will be described with reference to FIG. 12. FIG. 12 illustrates an example of a transmission mode management table. In the transmission mode management table, for example, IDs of state change data (information indicating types of state change), information indicating degrees of certainty, information indicating degrees of emergency, and information indicating the transmission modes are associated with one another. The transmission mode management table is created in advance and stored, for example, in the storage device 16.

The information indicating degrees of certainty is information indicating whether state change data needs to be certainly transmitted to the server 12. State change data whose degree of certainty is “1: Yes” needs to be certainly transmitted to the server 12. State change data whose degree of certainty is “0: No” need not be transmitted to the server 12.

The information indicating degrees of emergency is information indicating whether state change data needs to be immediately transmitted to the server 12. State change data whose degree of emergency is “1: Yes” needs to be immediately transmitted to the server 12. State change data whose degree of emergency is “0: No” need not be immediately transmitted to the server 12.

Degrees of certainty and degrees of emergency are determined in advance on the basis of the type of state change. The degrees of certainty and the degrees of emergency are examples of priority levels of state changes.

The transmission modes are determined in advance on the basis of the degree of certainty and the degree of emergency. That is, the transmission modes are determined in advance on the basis of the type of state change.

Use frequency data whose degree of certainty is “0: No” and whose degree of emergency is “0: No”, for example, is associated with a transmission mode “0: Mode A for transmission within certain period of time”. Since this use frequency data neither requires emergency nor certainty, mode A is associated as the transmission mode. The same holds for power consumption data. That is, these types of state change data are desirably transmitted to the server 12, but need not necessarily be transmitted to the server 12 depending on the load of the MFP 10, a load of the network, the load of the server 12, and other failures. Mode A, therefore, is associated with these types of state change data.

Because failure prediction data, payment data, consumable replacement data, and mechanical option data are data whose degrees of certainty are “1: Yes” and whose degrees of emergency are “0: No”, a transmission mode “1: Mode B for certain transmission within certain period of time” is associated with these types of state change. That is, since these types of state change do not require emergency, these types of state change data need not be immediately transmitted to the server 12 after generation thereof. Because these types of state change need to be managed by the server 12, on the other hand, these types of state change data need to be certainly transmitted to the server 12. Mode B, therefore, is associated with these types of state change data.

Because failure data is data whose degree of certainty is “1: Yes” and whose degree of emergency is “1: Yes”, a transmission mode “3: Mode C for certain, immediate transmission” is associated with the failure data. That is, if a failure occurs in the MFP 10, the MFP 10 needs to be repaired. The user or the like, therefore, needs to be immediately notified of the failure through the server 12. Mode C, therefore, is associated with the failure data.

If generated state change data is failure data, for example, an ID is 1, Bit1=certainty is 1, Bit0=emergency is 1, and Bit10=transmission mode is 3. Information indicating the transmission mode (e.g., a value of 3) is associated with the state change data, held along with the state change data, and set in an array of the state change data to be transmitted.

“0: Mode A for transmission within certain period of time” and “1: Mode B for certain transmission within certain period of time” are examples of a second mode, and “3: Mode C for certain, immediate transmission” is an example of a first mode.

Step S44 and later steps will be described hereinafter. If the state change is a failure (YES in step S44), the information type identification unit 32 determines a failure level (step S45).

Failure levels will be described with reference to FIG. 13. FIG. 13 illustrates an example of a failure level table. In the failure level table, for example, information indicating types of failure and information indicating failure levels are associated with each other. For example, the failure level table is created in advance, and data regarding the failure level table is stored in the storage device 16.

A relatively high failure level (1: High) is associated with a failure of a controller (e.g., control device 24). A relatively low failure level (0: Low) is associated with other types of failure (e.g., a failure of a printing device, a failure of a scanning device, and a failure of a paper tray). Failure levels according to degrees of importance (priority levels) of types of failure are thus determined.

If a failure that has occurred in the MFP 10 is a failure of a controller, for example, the information type identification unit 32 identifies “1: High” as a failure level.

A degree of emergency of repair or the like varies depending on a failure level of the MFP 10, a type of failure, and the like. For this reason, a communication mode is set in accordance with the failure level, as described later.

If the operation state of the MFP 10 does not change (NO in step S40), or if the state change is not to be reported (NO in step S41), the process ends. If the state change is not a failure (NO in step S44), the process ends without determining a failure level.

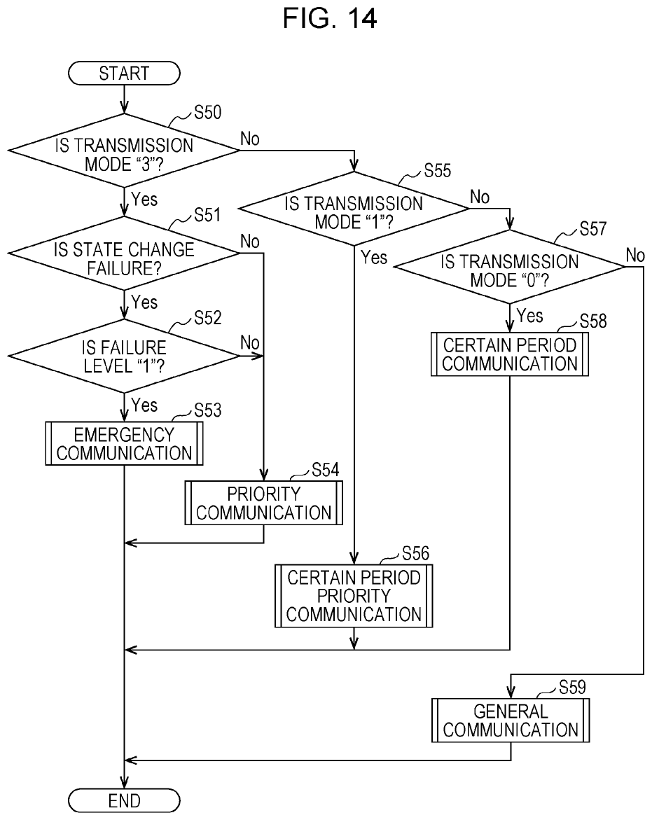

Step S18 illustrated in FIG. 6 (determination of a communication mode) will be described in detail hereinafter with reference to FIG. 14. FIG. 14 is a flowchart illustrating the determination of a communication mode.

If the transmission mode identified in step S43 is “3: Mode C for certain, immediate transmission” (YES in step S50), the state change is a failure (YES in step S51), and a failure level is “1: High” (YES in step S52), the data transmission unit 38 performs emergency communication (emergency communication mode) (step S53). That is, since a failure whose degree of emergency is high has occurred, emergency communication is performed to immediately notify the server 12 of the failure. The emergency communication will be described in detail later. The emergency communication is an example of a third mode.

If the state change is not a failure (NO in step S51), or if the failure level is not “1: High” (NO in step S52), the data transmission unit 38 performs priority communication (priority communication mode) (step S54). If a state change is not a failure (even if the transmission mode is “3”) or if a failure whose degree of emergency is low has occurred, a degree of emergency of reporting of the state change is lower than when a failure level is high. Therefore, priority communication, whose degree of emergency is lower than that of emergency communication, is performed. Priority communication will be described in detail later. Priority communication is an example of a fourth mode.

If the transmission mode identified in step S43 is not “3: Mode C for certain, immediate transmission” (NO in step S50) but “1: Mode B for certain transmission within certain period of time” (YES in step S55), the data transmission unit 38 performs certain period priority communication (an intermediate communication mode between the normal communication mode and the priority communication mode) (step S56). A degree of emergency of a state change corresponding to the transmission mode “1” is lower than that of a state change corresponding to the transmission mode “3”. Therefore, certain period priority communication, whose degree of emergency is lower than that of priority communication, is performed. Certain period priority communication will be described in detail later.

If the transmission mode is not “1: Mode B for certain transmission within certain period of time” (NO in step S55) but “0: Mode A for transmission within certain period of time” (YES in step S57), the data transmission unit 38 performs certain period communication (a communication mode that is an example of the normal communication mode) (step S58). As described above, a degree of certainty of a state change corresponding to the transmission mode “0” is lower than that of a state change corresponding to the transmission mode “1”. Therefore, the certain period communication, whose degree of certainty is lower than that of the certain period priority communication, is performed. The certain period communication process will be described in detail later.

If the transmission mode is not “0: Mode A for transmission within certain period of time” (NO in step S57), the data transmission unit 38 performs general communication (a communication mode that is an example of the normal communication mode) (step S59). Some state changes do not correspond to any of the transmission modes “0”, “1”, and “3”. For example, a state change whose degree of certainty and degree of emergency are even lower than those of a state change corresponding to the transmission mode “0” does not correspond to any of the transmission modes “0”, “1”, and “3”. A degree of certainty and a degree of emergency of such a state change is even lower than those of a state change corresponding to the transmission mode “0”. Therefore, general communication, whose degree of certainty and degree of emergency are lower than those of certain period communication, is performed. General communication will be described in detail later.

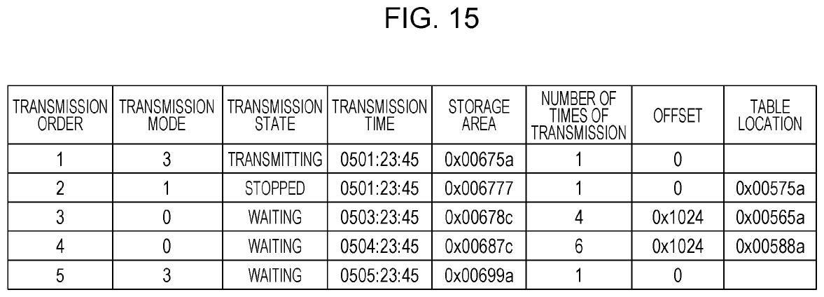

The communication control table will be described in detail hereinafter with reference to FIG. 15. FIG. 15 illustrates an example of the communication control table.

In the communication control table, for example, information indicating the order of transmission of state change data, information indicating transmission modes for the state change data, information indicating transmission states of the state change data, information indicating transmission times, information indicating storage areas storing the state change data (e.g., address information), information indicating the number of times of transmission, information indicating offsets (e.g., address information), and information indicating locations of tables (e.g., address information) are associated with one another.

The order of transmission basically corresponds to the order of occurrence of state changes in the MFP 10. The MFP 10 usually transmits a piece of state change data first in the order of transmission to the server 12 first, but depending on the transmission mode, the order of transmission of state change data is changed. For example, the order of transmission of state change data corresponding to the transmission mode “3” is earlier than the order of transmission of state change data corresponding to the transmission mode “0” or “1”.

As described later, the MFP 10 might transmit divided pieces of state change data to the server 12. The number of times of transmission indicates the number of times of transmission of the divided pieces of data. The number of times of transmission of state change data that has not been divided is set to 1. The information indicating offsets is used to identify storage locations of divided pieces of data.

The information indicating locations of tables indicates storage areas of transmission schedule tables used for the transmission modes “0: Mode A for transmission within certain period of time” and “1: Mode B for certain transmission within certain period of time” of state change data. That is, the term “tables” refers to the transmission schedule tables. If the transmission mode is “3: Mode C for certain, immediate transmission”, a transmission schedule table is not used. Information indicating a location of a table, therefore, is not associated with state change data corresponding to the transmission mode “3”.

For example, a transmission mode associated with a piece of state change data first in the order of transmission is “3: Mode C for certain, immediate transmission”, and the MFP 10 is transmitting the piece of state change data to the server 12 (transmitting). A piece of state change data second in the order of transmission is stopped, and other pieces of state change data are waiting for transmission.

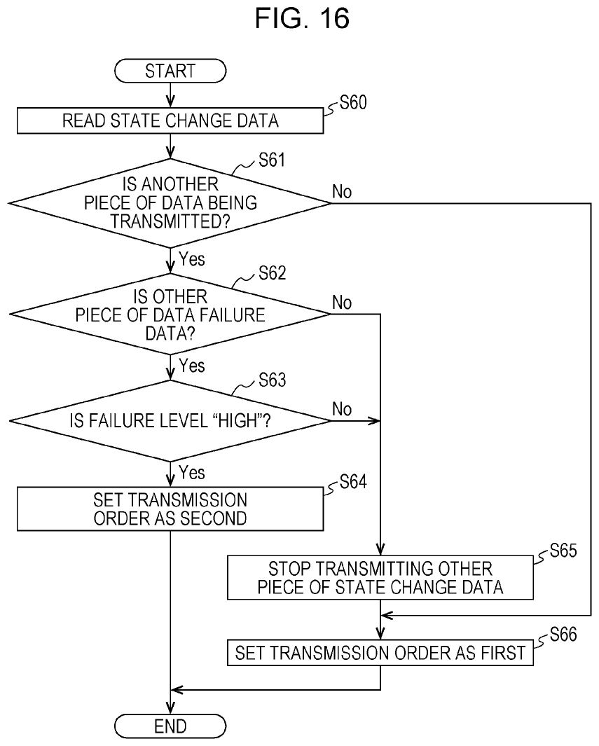

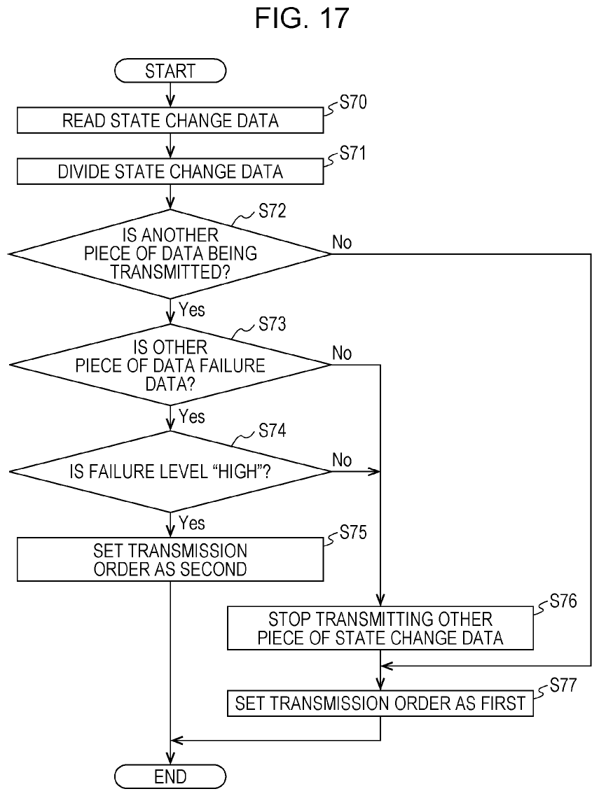

Emergency communication (emergency communication mode) will be described in detail hereinafter with reference to FIG. 16. FIG. 16 is a flowchart illustrating emergency communication.

The data transmission unit 38 reads state change data held by the information holding unit 36 (e.g., stored in the storage device 16) and subjected to emergency communication (step S60).

Next, the data transmission unit 38 determines whether another piece of state change data is being transmitted to the server 12 (step S61).

If another piece of state change data is being transmitted to the server 12 (YES in step S61), the data transmission unit 38 determines whether the other piece of state change data is failure data (step S62).

If the other piece of state change data is failure data (YES in step S62), the data transmission unit 38 determines whether a failure level indicated by the failure data is “1: High” (step S63).

The data transmission unit 38 compares a degree of failure (failure level) relating to the state change data read in step S60 with a degree of failure (failure level) relating to the other piece of state change data and transmits the state change data or the other piece of state change data to the server 12 earlier than the other in accordance with a result of the comparison of the two failure levels. If the failure level of the state change data is higher than that of the other piece of state change data, for example, the data transmission unit 38 transmits the state change data to the server 12 earlier than the other piece of state change data. If the failure level of the other piece of state change data is the same as or higher than that of the state change data, on the other hand, the data transmission unit 38 transmits the other piece of state change data to the server 12 earlier than the state change data. This process will be described in more detail hereinafter.

If the failure level of the other piece of state change data is “1: High” (YES in step S63), the data transmission unit 38 sets the order of transmission of the state change data read in step S60 as second in the communication control table (step S64). After completing the transmission of the failure data that is being transmitted, the data transmission unit 38 transmits the state change data to the server 12. The transmission of state change data will be described in detail later.

A specific example will be described. In the example illustrated in FIG. 15, the transmission mode “3” is associated with pieces of state change data that are first and fifth, respectively, in the order of transmission. It is assumed that these pieces of state change data are both failure data and a failure level of the first piece of failure data is “1: High”. The first piece of failure data is being transmitted. The fifth piece of state change data is the state change data read in step S60. In this case, the order of transmission of the fifth piece of state change data is changed to second, and the second piece of state change data (originally the fifth piece of state change data) is transmitted to the server 12 after the transmission of the first piece of failure data is completed. Pieces of state change data that are originally second, third, and fourth, respectively, in the order of transmission are delayed as third to fifth pieces of state change data. Failure data is thus given priority in transmission and transmitted to the server 12 earlier than other pieces of state change data that are not failure data.

If failure data that has not been transmitted has already been registered in the communication control table (e.g., if the failure data that has not been transmitted is set as second in the order of transmission), the data transmission unit 38 sets the state change data later (e.g., third) in the order of transmission than the failure data that has not been transmitted. After completing the transmission of the failure data that is being transmitted, the data transmission unit 38 transmits the second piece of failure data to the server 12 and then transmits the state change data to the server 12. If failure data whose failure level is “1: High” is included in the second to fourth pieces of state change data in the example illustrated in FIG. 15, for example, the failure data is moved to second in the order of transmission, and the fifth pieces of failure data is moved to third in the order of transmission.

If the other piece of state change data that is being transmitted is not failure data (NO in step S62), or if the failure level of the other piece of state change data is not “1: High” (NO in step S63), the data transmission unit 38 stops transmitting the other piece of state change data (step S65). The data transmission unit 38 then sets the state change data read in step S60 as first in the order of transmission (step S66) and transmits the state change data to the server 12 earlier than the other piece of state change data. After completing the transmission of the state change data, the data transmission unit 38 resumes the transmission of the other piece of state change data to the server 12.

If the other piece of state change data is not being transmitted (NO in step S61), the data transmission unit 38 sets the state change data read in step S60 as first in the order of transmission (step S66) and transmits the state change data to the server 12.

As described above, if state change data is failure data and a failure level of the failure data is high, the failure data is transmitted to the server 12 earlier than other pieces of state change data that are not failure data. In doing so, the server 12 is notified of a failure, whose degree of emergency is higher than those of state changes that are not failures, earlier than other state changes that are not failures. In addition, since failure data whose failure level is higher is transmitted to the server 12 earlier, the server 12 is notified of a failure whose degree of emergency is high earlier than a failure whose degree of emergency is low.

Priority communication (priority communication mode) will be described in detail hereinafter with reference to FIG. 17. FIG. 17 is a flowchart illustrating priority communication.

The data transmission unit 38 reads state change data held by the information holding unit 36 (e.g., stored in the storage device 16) and subjected to priority communication (step S70).

Next, the data transmission unit 38 divides the state change data into a plurality of state change data parts (step S71). For example, the data transmission unit 38 divides the state change data in units of 200 bytes, 1 kilobyte, or the like. The data transmission unit 38 sets the number of state change data parts in the communication control table (refer to FIG. 15) as the number of times of transmission and a value of the division as the offset.

If another piece of state change data is being transmitted to the server 12 (YES in step S72), the other piece of state change data is failure data (YES in step S73), and a failure level of the failure data is “1: High” (YES in step S74), the data transmission unit 38 sets the state change data in the communication control table as second in the order of transmission (step S75). After completing the transmission of the failure data that is being transmitted, the data transmission unit 38 transmits the state change data to the server 12. At this time, the data transmission unit 38 transmits the plurality of state change data parts generated as a result of the division one by one or a plurality of pieces at a time. The transmission of state change data will be described in detail later.

If the other piece of state change data that is being transmitted is not failure data (NO in step S73), or if the failure level of the other piece of state change data is not “1: High” (NO in step S74), the data transmission unit 38 stops transmitting the other piece of state change data (step S76). The data transmission unit 38 then sets the state change data read in step S70 as first in the order of transmission (step S77) and transmits the state change data to the server 12. After completing the transmission of the state change data, the data transmission unit 38 resumes the transmission of the other piece of state change data to the server 12. That is, in priority communication mode, too, the failure levels of the state change data and the other piece of state change data are compared with each other, and the state change data or the other piece of state change data is transmitted to the server 12 earlier than the other on the basis of a result of the comparison.

If another piece of state change data is not being transmitted (NO in step S72), the data transmission unit 38 sets the state change data read in step S70 as first in the order of transmission (step S77) and transmits the state change data to the server 12.

A degree of emergency of state change data subjected to priority communication is the second highest, following that of failure data whose failure level is high. By transmitting the state change data to the server 12 after transmitting failure data whose failure level is high, therefore, data transmission according to the degrees of emergency is achieved. In addition, by dividing state change data into a plurality of pieces, the load of the network in each transmission operation is reduced compared to when the state change data is transmitted to the server 12 as it is. When state change data is divided and transmitted to the server 12, not all pieces of data might be transmitted due to a network error or the like. Since a degree of emergency of failure data whose failure level is high is the highest, the failure data needs to be certainly transmitted to the server 12. The failure data, therefore, is transmitted to the server 12 as it is. In doing so, the failure data whose failure level is high is certainly transmitted to the server 12.

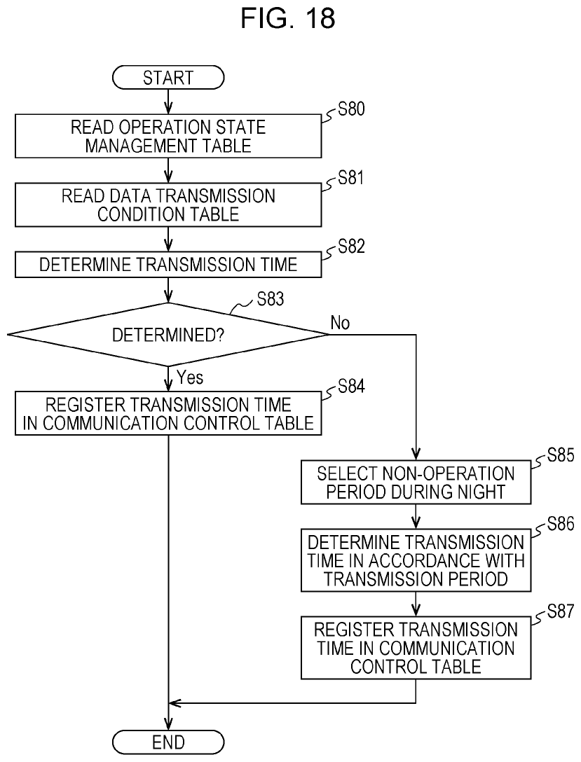

General communication (a communication mode that is an example of the normal communication mode) will be described in detail hereinafter with reference to FIG. 18. FIG. 18 is a flowchart illustrating general communication.

The data transmission unit 38 reads the operation state management table stored in the storage device 16 (step S80) and the data transmission condition table, which has been transmitted from the server 12, from the storage device 16 (step S81).

Next, the data transmission unit 38 determines a time at which state change data is to be transmitted (step S82). For example, the data transmission unit 38 identifies a period when the MFP 10 is not operating by referring to the operation state management table and a period when there is a transmission request (a period associated with “1(Transmission)”) by referring to the data transmission condition table. The data transmission unit 38 identifies a period when the MFP 10 is not operating and there is a transmission request. In the examples illustrated in FIGS. 7 and 10, a period when the MFP 10 is not operating and there is a transmission request is 08:16 to 08:30 on Monday. In this case, the data transmission unit 38 determines a middle time point (e.g., 08:23) of the period as a transmission time.

If a transmission time is determined (YES in step S83), that is, if a period when the MFP 10 is not operating and there is a transmission request is identified, the data transmission unit 38 registers the transmission time (e.g., 08:23) in the communication control table as a time at which the state change data subjected to general communication is to be transmitted (step S84).

If a transmission time is not determined (NO in step S83), that is, if a period when the MFP 10 is not operating and there is a transmission request is not identified, the data transmission unit 38 refers to the operation state management table and selects a non-operation part (a period when the MFP 10 is not operating) of a period (e.g., during the night, namely 00:00 to 05:00) when the MFP 10 is not expected to be operating (step S85).

Next, the data transmission unit 38 determines a transmission time in accordance with a specified transmission period (step S86). Because 0 to 5 minutes is determined as a transmission period in the example illustrated in FIG. 10, the data transmission unit 38 determines the transmission time within a range of 0 to 5 minutes, namely, for example, 00:05.

The data transmission unit 38 registers the transmission time determined in accordance with the transmission period as the transmission time of the state change data subjected to general communication (step S87).

If there is no non-operation part during the night (00:00 to 05:00), a non-operation part may be selected in another period (e.g., early morning or midnight). In addition, if the MFP 10 has a function of automatically turning on and off, a transmission time may be set in a period when the MFP 10 is off. In this case, the MFP 10 automatically turns on at the transmission period and transmits state change data to the server 12.

State change data subjected to general communication is data whose degree of certainty and degree of emergency are both low and that need not be immediately transmitted to the server 12 compared to state change data subjected to emergency communication or priority communication. By transmitting state change data subjected to general communication to the server 12 in a period when the MFP 10 is not operating and the server 12 requests transmission, therefore, use of the MFP 10 is not affected due to the transmission of the state change data, and an increase in the load of the server 12 is suppressed.

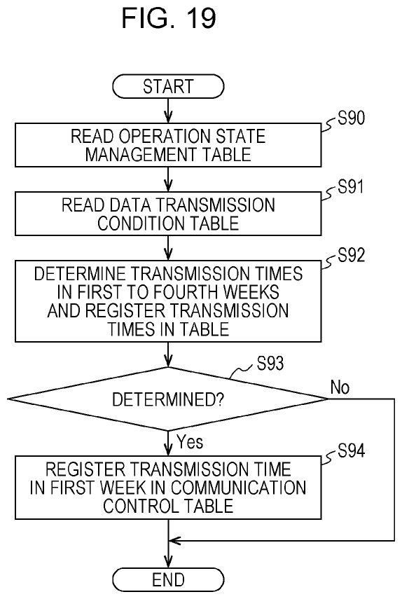

Certain period communication (a communication mode that is an example of the normal communication mode) will be described in detail hereinafter with reference to FIG. 19. FIG. 19 is a flowchart illustrating certain period communication.

The data transmission unit 38 reads the operation state management table stored in the storage device 16 (step S90) and the data transmission condition table, which has been transmitted from the server 12, from the storage device 16 (step S91).

Next, the data transmission unit 38 determines transmission times of state change data in first to fourth weeks and registers the transmission times in a table specifying a transmission schedule of the state change data in the first to fourth weeks (step S92). For example, the data transmission unit 38 identifies a period when the MFP 10 is not operating by referring to the operation state management table and identifies a period when there is a transmission request (a period associated with “1(Transmission)”) by referring to the data transmission condition table. The data transmission unit 38 identifies a period when the MFP 10 is not operating and there is a transmission request. In the examples illustrated in FIGS. 7 and 10, a period when the MFP 10 is not operating and there is a transmission request is 08:16 to 08:30 on Monday. In this case, the data transmission unit 38 determines a middle time point (e.g., 08:23) of the period as the transmission times in the first to fourth week and registers the transmission times in a transmission schedule table.

If it is possible to determine a plurality of transmission times, the data transmission unit 38 may change the transmission time between the first to fourth weeks. That is, the data transmission unit 38 may determine different transmission times for the first to fourth weeks.

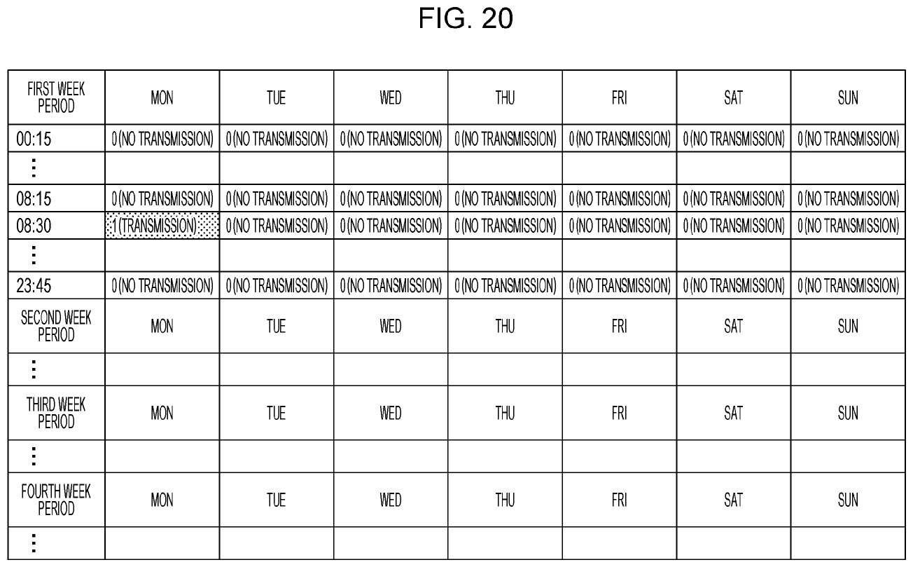

The transmission schedule table will be described with reference to FIG. 20. FIG. 20 illustrates an example of the transmission schedule table. The transmission schedule table specifies transmission times in the first to fourth weeks. In the example illustrated in FIG. 20, a time point (e.g., 08:23) in the period 08:16 to 08:30 on Monday is registered as a transmission time. The same transmission time may be used for the first to fourth weeks, or different transmission times may be used for the first to fourth weeks.

If transmission times are determined (YES in step S93), that is, if a period when the MFP 10 is not operating and there is a transmission request is identified, the data transmission unit 38 registers the transmission time (e.g., 08:23) in the first week of the transmission schedule in the communication control table as a transmission time of the state change data subjected to certain period communication (step S94).

If transmission times are not determined (NO in step S93), the data transmission unit 38 does not register transmission times of the state change data in the communication control table.

State change data subjected to certain period communication is, as with state change data subjected to general communication, data whose degree of certainty and degree of emergency are both low and that need not be immediately transmitted to the server 12 compared to state change data subjected to emergency communication or priority communication. By transmitting state change data subjected to certain period communication to the server 12 in a period when the MFP 10 is not operating and the server 12 requests transmission, therefore, use of the MFP 10 is not affected due to the transmission of the state change data, and an increase in the load of the server 12 is suppressed.

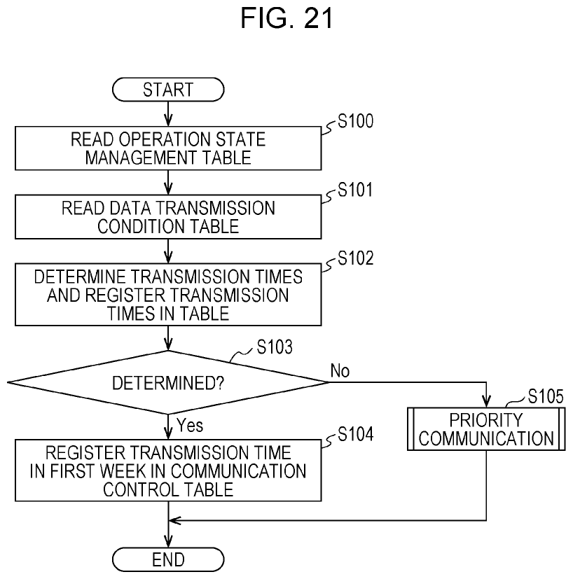

Certain period priority communication (an intermediate communication mode between the normal communication mode and the priority communication mode) will be described in detail hereinafter with reference to FIG. 21. FIG. 21 is a flowchart illustrating certain period priority communication.

The data transmission unit 38 reads the operation state management table stored in the storage device 16 (step S100) and the data transmission condition table, which has been transmitted from the server 12, from the storage device 16 (step S101).

Next, the data transmission unit 38 determines transmission times of state change data in first to fourth weeks and registers the transmission times in a table specifying a transmission schedule of the state change data in the first to fourth weeks (step S102). This operation is the same as step S92 described above.

If transmission times are determined (YES in step S103), the data transmission unit 38 registers the transmission time in the first week of the transmission schedule in the communication control table as a transmission time of the state change data subjected to certain period priority communication (step S104).

If transmission times are not determined (NO in step S103), the data transmission unit 38 performs priority communication (step S105).

State change data subjected to certain period priority communication has a degree of certainty and a degree of emergency between those of state change data subjected to priority communication and those of state change data subjected to certain period communication. If transmission times are determined, therefore, the state change data is transmitted to the server 12 through the same operation as certain period communication. If not, the state change data is transmitted to the server 12 through priority communication. As a result, use of the MFP 10 is not affected due to the transmission of the state change data. In addition, the state change data subjected to certain period priority communication is transmitted to the server 12 while suppressing an increase in the load of the server 12.

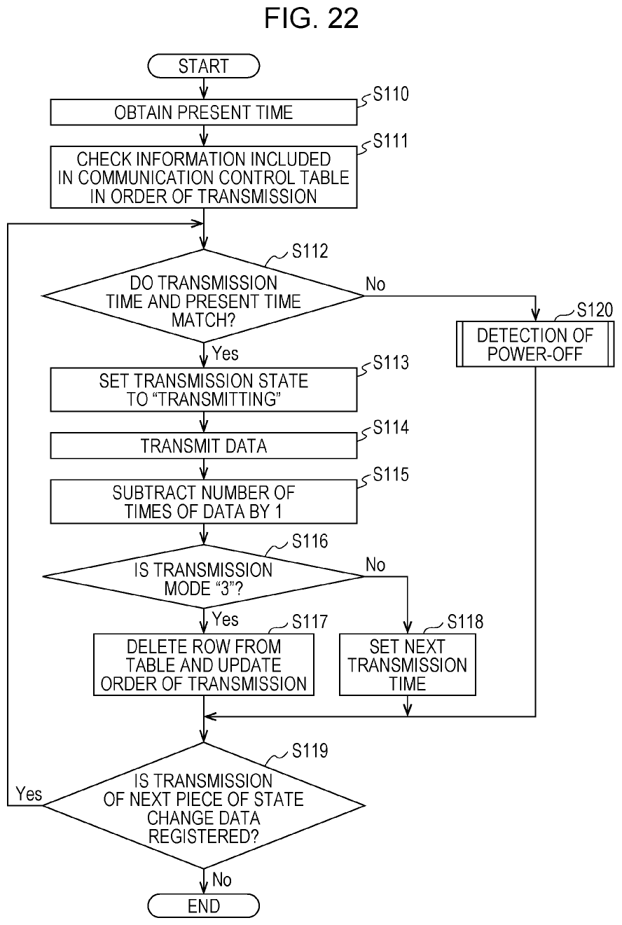

The transmission of state change data (step S19 illustrated in FIG. 6) will be described in detail hereinafter with reference to FIG. 22. FIG. 22 is a flowchart illustrating the transmission.

The data transmission unit 38 obtains present time information (step S110) and checks information included in the communication control table (refer to FIG. 15) in order of transmission (step S111).

If a transmission time and present time match with respect to state change data first in the order of transmission (YES in step S112), the data transmission unit 38 sets a transmission state of the state change data to “transmitting” in the communication control table (step S113). Even when the transmission time and the present time do not match, the data transmission unit 38 may set the transmission state to “transmitting” if a difference between the transmission time and the present time is within a predetermined range (e.g., 5 minutes).

The data transmission unit 38 reads the state change data from a storage area of the state change data and transmits the state change data to the server 12 through the communication device 14 (step S114). If the number of times of transmission associated with the state change data is 1 or more, the data transmission unit 38 determines, as a storage area, a value (address) obtained by adding an offset to information indicating the storage area.

The data transmission unit 38 subtracts the number of times of transmission associated with the state change data by 1 (step S115). The data transmission unit 38 also changes the transmission time to a time point one minute later. The data transmission unit 38 then transmits the state change data to the server 12 until the number of times of transmission becomes 0. If the state change data has been divided, the number of divisions has been registered as the number of times of transmission, and state change data parts, which have been generated as a result of the division, as many as the number of times of transmission are transmitted to the server 12. If the state change data has not been divided, the number of times of transmission is 1. After the state change data is transmitted to the server 12, therefore, the number of times of transmission becomes 0.

If a transmission mode of the state change data is “3: Mode C for certain, immediate transmission” (YES in step S116), the data transmission unit 38 deletes registration information regarding the state change data (a row in which the state change data is registered) from the communication control table and updates the order of transmission (step S117).

If the transmission mode of the state change data is not “3” (NO in step S116), the data transmission unit 38 refers, on the basis of information indicating a location of a table associated with the state change data in the communication control table, to a transmission schedule table regarding the state change data stored at the location, identifies a transmission time registered in the transmission schedule table, and sets the transmission time as a next transmission time (step S118).

If transmission of a next piece of state change data is registered in the communication control table (YES in step S119), the process returns to step S112. The data transmission unit 38 checks all pieces of state change data registered in the communication control table and transmits the pieces of state change data to the server 12.

If transmission of a next piece of state change data is not registered in the communication control table (NO in step S119), the process ends.

If the transmission time and the present time do not match (NO in step S112), detection of power-off is performed (step S120). After the detection of power-off is performed, step S119 and later steps are performed.

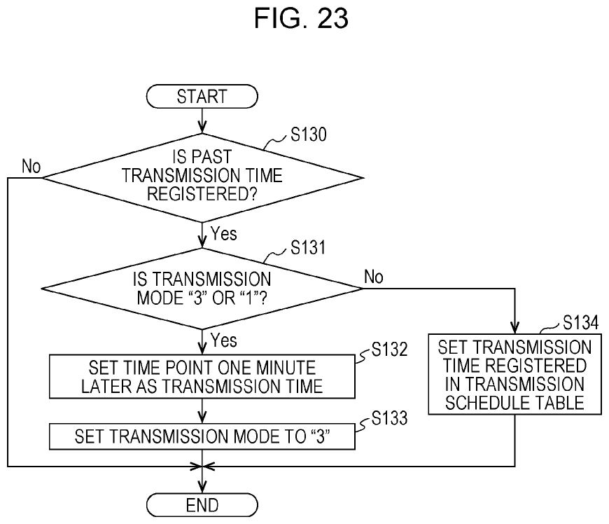

The detection of power-off will be described in detail hereinafter with reference to FIG. 23. FIG. 23 is a flowchart illustrating the detection of power-off.

The data transmission unit 38 checks whether transmission of state change data associated with a past transmission time is registered in the communication control table (step S130).

If transmission of state change data associated with a past transmission time is registered in the communication control table (YES in step S130), and if a transmission mode associated with the state change data is “3” or “1” (YES in step S131), the data transmission unit 38 sets a time point one minute later as a transmission time of the state change data (step S132) and the transmission mode of the state change data to “3: Mode C for certain, immediate transmission” (step S133).

When a past transmission time is registered in the communication control table, it means that the MFP 10 was off and state change data was not transmitted at the transmission time. In this case, the data transmission unit 38 sets a time point one minute later as a transmission time so that the state change data is immediately transmitted to the server 12. The data transmission unit 38 also sets the transmission mode to “3” so that the state change data is immediately transmitted to the server 12. In doing so, state change data that was not transmitted to the server 12 while the MFP 10 was off is transmitted to the server 12. State change data whose transmission mode is “3” or “1” requires certainty in transmission, and such state change data is immediately transmitted to the server 12.

If the transmission mode associated with the state change data is not “3” or “1” (NO in step S131), the data transmission unit 38 refers, on the basis of information indicating a table location associated with the state change data in the communication control table, to a transmission schedule table regarding the state change data stored at the location, identifies a transmission time registered in the transmission schedule table, and sets the transmission time as a next transmission time (step S134). In doing so, even if a transmission mode of state change data is not “3” or “1”, the state change data is transmitted to the server 12.

The MFP 10 and the server 12 are each achieved through, for example, combination of hardware and software. More specifically, the MFP 10 and the server 12 each include one or a plurality of processors that are not illustrated, such as CPUs. The one or plurality of processors read and execute a program stored in a storage device that is not illustrated to achieve the functions of the components of each of the MFP 10 and the server 12. The program is stored in the storage device through a recording medium such as a compact disc (CD) or a digital versatile disc (DVD) or a communication path such as a network. In another example, the components of the MFP 10 and the server 12 may each be achieved by a hardware resource such as a processor, an electronic circuit, or an application-specific integrated circuit (ASIC). In this case, a device such as a memory may be used to achieve each of the MFP 10 and the server 12. In another example, the components of the MFP 10 and the server 12 may each be achieved by a digital signal processor (DSP), a field-programmable gate array (FPGA), or the like.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
an obtaining unit that obtains, from an external apparatus, a data transmission condition that specifies a timing at which data regarding a state change of the information processing apparatus is transmitted to the external apparatus and that has been created on a basis of at least of an operation state of the information processing apparatus; and
a transmission unit that, if the data is generated as a result of a state change of the information processing apparatus, establishes, in accordance with the state change of the information processing apparatus, a first mode in which the data is transmitted to the external apparatus regardless of the timing specified by the data transmission condition or a second mode in which the data is transmitted to the external apparatus in accordance with the timing specified by the data transmission condition.

2. The information processing apparatus according to claim 1,
wherein the first mode includes a third mode in which the data is transmitted to the external apparatus without being divided and a fourth mode in which the data is divided and transmitted to the external apparatus a plurality of times, and
wherein the control unit establishes the second mode, the third mode, or the fourth mode in accordance with a priority level of the state change of the information processing apparatus.

3. The information processing apparatus according to claim 2,
wherein, if the state change of the information processing apparatus is a change relating to a failure of the information processing apparatus, the control unit establishes the third mode or the fourth mode in accordance with a level of the failure.

4. The information processing apparatus according to claim 2,
wherein, if the data corresponding to the first mode is generated while the information processing apparatus is transmitting another piece of data to the external apparatus, the transmission unit transmits the data to the external apparatus while stopping the transmission of the other piece of data and, after completing the transmission of the data, resumes the transmission of the other piece of data.

5. The information processing apparatus according to claim 3,
wherein, if the data corresponding to the first mode is generated while the information processing apparatus is transmitting another piece of data to the external apparatus, the transmission unit transmits the data to the external apparatus while stopping the transmission of the other piece of data and, after completing the transmission of the data, resumes the transmission of the other piece of data.

6. The information processing apparatus according to claim 3,
wherein, if the data corresponding to the first mode is generated while the information processing apparatus is transmitting another piece of data relating to a failure to the external apparatus, the transmission unit transmits either the other piece of data or the data earlier than the other on a basis of a result of comparison between a level of the failure relating to the other piece of data and the level of the failure relating to the data.

7. The information processing apparatus according to claim 1,
wherein, if the data corresponding to the second mode is generated and it is difficult to transmit the data to the external apparatus in accordance with the timing specified by the data transmission condition, the transmission unit transmits the data to the external apparatus when the information processing apparatus is not operating.

8. The information processing apparatus according to claim 1,
wherein, if the information processing apparatus is off at the timing specified by the data transmission condition, the transmission unit transmits, to the external apparatus in the first mode or the second mode for which the timing has been updated in accordance with the state change that has generated the data after the information processing apparatus turns on, the data that should have been transmitted at the timing.

9. A non-transitory computer readable medium storing a program causing a computer to function as:
an obtaining unit that obtains, from an external apparatus, a data transmission condition that specifies a timing at which data regarding a state change of an information processing apparatus is transmitted to the external apparatus and that has been created on a basis of at least of an operation state of the information processing apparatus; and
a transmission unit that, if the data is generated as a result of a state change of the information processing apparatus, establishes, in accordance with the state change of the information processing apparatus, a first mode in which the data is transmitted to the external apparatus regardless of the timing specified by the data transmission condition or a second mode in which the data is transmitted to the external apparatus in accordance with the timing specified by the data transmission condition.

10. An information processing apparatus comprising:
obtaining means for obtaining, from an external apparatus, a data transmission condition that specifies a timing at which data regarding a state change of the information processing apparatus is transmitted to the external apparatus and that has been created on a basis of at least of an operation state of the information processing apparatus; and
transmission means for, if the data is generated as a result of a state change of the information processing apparatus, establishing, in accordance with the state change of the information processing apparatus, a first mode in which the data is transmitted to the external apparatus regardless of the timing specified by the data transmission condition or a second mode in which the data is transmitted to the external apparatus in accordance with the timing specified by the data transmission condition.
